(19) United States
(12) Patent Application Publication
(10) Pub. No.: US 2025/0335556 A1
(43) Pub. Date: Oct. 30, 2025

(54) COMMUTATIVE ENCRYPTION AND WATERMARKING METHOD UTILIZING DNA BASE COMPLEMENTARY DYNAMIC ENCRYPTION FOR HIGH-DEFINITION MAP

(71) Applicant: LANZHOU JIAOTONG UNIVERSITY, Lanzhou (CN)

(72) Inventors: Haowen YAN, Lanzhou (CN); Liming ZHANG, Lanzhou (CN); Tao TAN, Lanzhou (CN); Min DENG, Changsha (CN); Shihong DU, Beijing (CN); Xinchang ZHANG, Guangzhou (CN); Shen YING, Wuhan (CN)

(21) Appl. No.: 19/007,594

(22) Filed: Jan. 2, 2025

(30) Foreign Application Priority Data
Apr. 24, 2024 (CN) 202410497498.0

(51) Int. Cl. G06F 21/16

(52) U.S. Cl. CPC G06F 21/16

(57) ABSTRACT

Disclosed is a commutative encryption and watermarking method utilizing deoxyribonucleic acid (DNA) base complementary dynamic encryption for a high-definition map. According to the method, on the basis of a DNA base pair complementary principle and data features of the high-definition map in the OpenDRIVE format, a commutative encryption and watermarking algorithm based on base pair complementary dynamic encryption for a high-definition map. In an encryption method, cubic curve parameters configured to denote elevation elements and lane widths in data are encrypted through a nucleotide base complementary principle in DNA. In a watermarking method, a number of elevation elements and lanes is not influenced by encryption, and the invariant feature is used to generate a zero-watermark. Interchangeability of encryption and watermarking is obtained.

### TECHNICAL FIELD

The present disclosure belongs to the technical field of geographic information security, and relates to a commutative encryption and watermarking method utilizing deoxyribonucleic acid (DNA) base complementary dynamic encryption for a high-definition map.

### BACKGROUND

With emergence of a new round of scientific and technological revolution and industrial transformation, smart automobiles have marked a strategic direction of development of the global automobile industry. As a key element of intelligent driving, a high-definition map provides accurate navigation information for drivers because it is accurate, real-time and detailed. It can also ensure precise environmental awareness and path planning for autonomous intelligent driving vehicles. However, as high-definition maps are used in transportation systems and autonomous driving, a series of complex challenges have appeared, including problems in security, privacy protection, data credibility and other aspects. The high-definition maps, a new kind of national basic strategic information resource, involve military security and national defense security. Thus, it is necessary to take security protection measures at the technical level.

An encryption technology and a watermarking technology are common measures for data security protection. The encryption technology can not only provide a secure storage environment for the high-definition maps, but can prevent criminals from illegally inquiring them. The watermarking technology can guarantee copyright protection for the high-definition maps, prevent criminals from maliciously tampering with them, and ensure integrity of the high-definition maps during their use. The encryption and watermarking technologies have been widely used in fields of images and vector geographic data. Moreover, targeted encryption and watermarking technologies have been fully studied. In order to ensure secure storage and copyright protection of data, a solution for commutative encryption and watermarking has become an advantageous choice for data security. A commutative encryption technology has functions of both encryption and watermarking. For example, Tan et al. arranged and encrypted a vector map. Since coordinate points of elements of the vector map never change after encryption, they used this feature to generate watermark information, thus achieving zero watermarking. In this way, interchangeability between encryption and watermarking can be realized. Guo et al. converted a vector map into polar coordinates and encrypted coordinate values under polar coordinates. Then, they embedded watermark information by adjusting a storage order of the coordinate points of elements in the vector map.

For solving a problem of lack of a security protection solution for a high-definition map, the present disclosure provides a commutative encryption and watermarking method utilizing deoxyribonucleic acid (DNA) base complementary dynamic encryption for a high-definition map. According to different requirements, a lossless encryption solution and a lossless watermarking solution can be provided for high-definition maps in an OpenDrive format. Also, a lossless and robust commutative encryption and watermarking solution can be provided for high-definition maps in an OpenDrive format, which provides a reliable method for security management and copyright protection.

### SUMMARY

An objective of the present disclosure is to provide a commutative encryption and watermarking method utilizing deoxyribonucleic acid (DNA) base complementary dynamic encryption for a high-definition map, so as to implement copyright protection of a high-definition map in an OpenDrive format during storage, transmission and use.

To achieve the objective, the present disclosure provides the following solution:

A zero watermarking method for a high-definition map in an OpenDrive format includes:
reading an original copyright image W, conducting Logistic mapping to encrypt the copyright image, and obtaining an encrypted copyright image;
using all elevations, superelevation and lane nodes in the high-definition map as elements, and computing numbers of parametric cubic curves in all the elements separately;
setting any two elements as one group, and establishing a stable index between watermark information and copyright information according to the following formula, where index denotes an index value, Nᵢ and Nⱼ denote numbers of parametric cubic curves in different elements in one combination respectively, Nₘ denotes a one-dimensional length of the copyright image, and n denotes a total number of all the elevations, the superelevation and the lane nodes in the high-definition map;

$$index = mod ( ( {N}_{i} \times {N}_{j} ) , {N}_{m} ) , i , j ∈ \{ 1 , 2 , … , n \} and i \neq j$$

determining the watermark information through a voting principle; setting a list having a consistent size with the copyright information for the voting principle, and recording the list as

$${M}^{′} = \{ {m}_{i}^{′} = 0 , i = 1 , 2 , … , {N}_{m} \} ,$$

where Nₘ denotes a size of the copyright information;
determining, in response to determining that numbers of parametric cubic curves under two nodes in one combination have consistent parity, watermark information at a corresponding index of the combination to be 1, and determining, in response to determining that numbers of parametric cubic curves under two nodes in one combination have no consistent parity, watermark information at a corresponding index of the combination to be 0;
conducting, after all nodes in the combination generate watermark information, binarization through the following formula;

$${M}^{′} ( index ) = \{ \begin{matrix}1 , & if {M}^{′} ( index ) > 0 \\ 0 , & if {M}^{′} ( index ) \leq 0\end{matrix} , index ∈ ( 0 , {N}_{m} )$$

conducting exclusive OR (XOR) operation on the generated watermark information and the copyright information M according to the following formula, and generating a zero-watermark M*, where XNOR denotes an XOR operation symbol; and
conducting XOR operation on a feature matrix and encrypted copyright information, and generating a zero-watermark.

$${M}^{*} = XNOR ( M , {M}^{′} )$$

A method for detecting zero-watermark information of a high-definition map in an OpenDrive format includes:
reading data of the high-definition map of to-be-detected watermark information;
generating same watermark information according to the zero watermarking method for data of a high-definition map, and conducting binarization;
conducting XOR operation on binarized watermark information and a zero-watermark of an original copyright image in an intellectual property management institution, and obtaining a to-be-detected copyright image; and
decrypting the to-be-detected copyright image, and obtaining a detected copyright image.

An encryption method for data of a high-definition map in an OpenDrive format includes:
conducting permutation and combination on nucleotide bases, so as to obtain 24 combinations in total;
generating two random sequences L₁ and L₂ through two-dimensional Henon-Sine mapping, where a definition of the Henon-Sine mapping is as shown in the following formula, where μ and δ denote parameters, xᵢ and yᵢ denote iterative values, a range of both the iterative values is (−∞,+∞), and mod denotes a complementary function;

$$\{ \begin{matrix}{x}_{i + 1} = mod ( ( 1 - {μsin}^{2} ( {x}_{i} ) + {y}_{i} ) , 1 ) \\ {y}_{i + 1} = mod ( δ {x}_{i} , 1 )\end{matrix}$$

conducting permutation and encryption on a combination of nucleotide bases through the random sequence L₁, so as to improve security;
using the random sequence L₂ as a control parameter, and determining a base combination corresponding to each parametric cubic curve in elevations, superelevation and lanes according to the following formula, where index denotes an index between the parametric cubic curve and the base combination, int denotes a least integer function, lᵢ denotes a random number in the random sequence L₂, k denotes an amplification parameter, and s denotes an S coordinate of the elevations, the superelevation and a starting position of the lanes;

$$index = mod ( int ( s \times {l}_{i} \times {10}^{k} ) , 24 ) , {l}_{i} ∈ {L}_{2}$$

determining, after a correspondence between each parametric cubic curve and a nucleotide base combination is determined, a complementary chain according to a DNA base complementary pairing principle, and determining, in response to determining that a base combination corresponding to four parameters (a,b,c,d) in one parametric cubic curve is (A,G,C,T), a complementary chain of the base combination as (T,C,G,A); and
encrypting (a,b,c,d) according to a permutation mode of the complementary chain, and replacing four parameters in an original parametric cubic curve with four encrypted parameters, so as to complete encryption.

A decryption method for data of a high-definition map in an OpenDrive format includes:
conducting same permutation and combination on nucleotide bases;
generating two same random sequences L₁ and L₂ through two-dimensional Henon-Sine mapping according to the encryption method for data of a high-definition map;
determining a base combination corresponding to each parametric cubic curve in elevations, superelevation and lanes through the encryption method for data of a high-definition map; and
deriving a corresponding complementary base according to a base; and finally, decrypting and replacing four parameters (a,b,c,d) in the parametric cubic curve according to a permutation mode of the complementary base, so as to complete decryption.

Disclosed is the commutative encryption and watermarking method utilizing DNA base complementary dynamic encryption for a high-definition map. On the basis of data features of the high-definition map in the OpenDrive format and a base complementary pairing principle of ribonucleotide in DNA, a lossless commutative encryption and watermarking method for a high-definition map is proposed. A feasible new idea is provided for secure storage, distribution and copyright protection of the data of the high-definition map.

### BRIEF DESCRIPTION OF THE DRAWINGS

To describe a technical solution in embodiments of the present disclosure or in the prior art more clearly, the accompanying drawings required for the description of the embodiments or the prior art will be briefly introduced below. Obviously, the accompanying drawings in the following description are merely schematic diagrams of the present disclosure. Those of ordinary skill in the art would also derive other accompanying drawings from the accompanying drawings without making inventive efforts.

FIG. 1 shows a flow diagram of a commutative encryption and watermarking method utilizing deoxyribonucleic acid (DNA) base complementary dynamic encryption for a high-definition map according to an embodiment of the present disclosure.

FIG. 2A shows illustrative data Data A of a high-definition map according to an embodiment of the present disclosure.

FIG. 2B shows illustrative data Data B of a high-definition map according to an embodiment of the present disclosure.

FIG. 2C shows illustrative data Data C of a high-definition map according to an embodiment of the present disclosure.

FIG. 2D shows illustrative data Data D of a high-definition map according to an embodiment of the present disclosure.

FIG. 3A shows a zero-watermark image of Data A constructed in a high-definition map according to an embodiment of the present disclosure.

FIG. 3B shows a zero-watermark image of Data B constructed in a high-definition map according to an embodiment of the present disclosure.

FIG. 3C shows a zero-watermark image of Data C constructed in a high-definition map according to an embodiment of the present disclosure.

FIG. 3D shows a zero-watermark image of Data D constructed in a high-definition map according to an embodiment of the present disclosure.

FIG. 4A shows an encryption visualization effect of Data A of a high-definition map according to an embodiment of the present disclosure.

FIG. 4B shows an encryption visualization effect of Data B of a high-definition map according to an embodiment of the present disclosure.

FIG. 4C shows an encryption visualization effect of Data C of a high-definition map according to an embodiment of the present disclosure.

FIG. 4D shows an encryption visualization effect of Data D of a high-definition map according to an embodiment of the present disclosure.

FIG. 5A shows a visualization effect of encrypted data of Data A encrypted in FIG. 4A after decryption according to an embodiment of the present disclosure.

FIG. 5B shows a visualization effect of encrypted data of Data B encrypted in FIG. 4B after decryption according to an embodiment of the present disclosure.

FIG. 5C shows a visualization effect of encrypted data of Data C encrypted in FIG. 4C after decryption according to an embodiment of the present disclosure.

FIG. 5D shows a visualization effect of encrypted data of Data D encrypted in FIG. 4D after decryption according to an embodiment of the present disclosure.

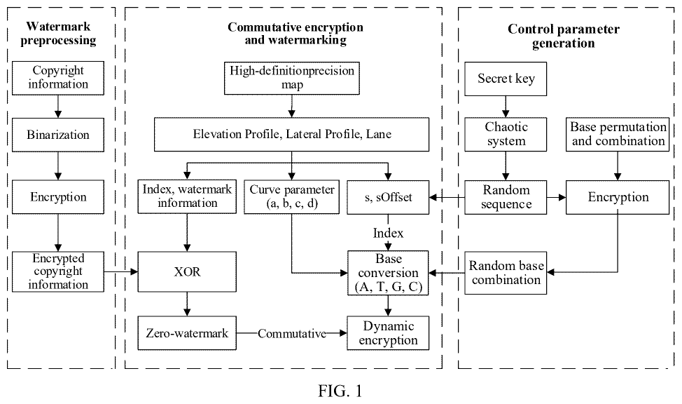

### DETAILED DESCRIPTION OF THE EMBODIMENTS

Technical solutions in embodiments of the present disclosure will be clearly and completely described below with reference to the accompanying drawings in the embodiments of the present disclosure. Obviously, the embodiments described are merely some embodiments rather than all embodiments of the present disclosure. Based on the embodiments of the present disclosure, all the other embodiments obtained by those of ordinary skill in the art without any creative effort fall within the protection scope of the present disclosure.

With reference to the accompanying drawings and the embodiments, a commutative encryption and watermarking method utilizing deoxyribonucleic acid (DNA) base complementary dynamic encryption for a high-definition map according to the present disclosure will be described in detail below.

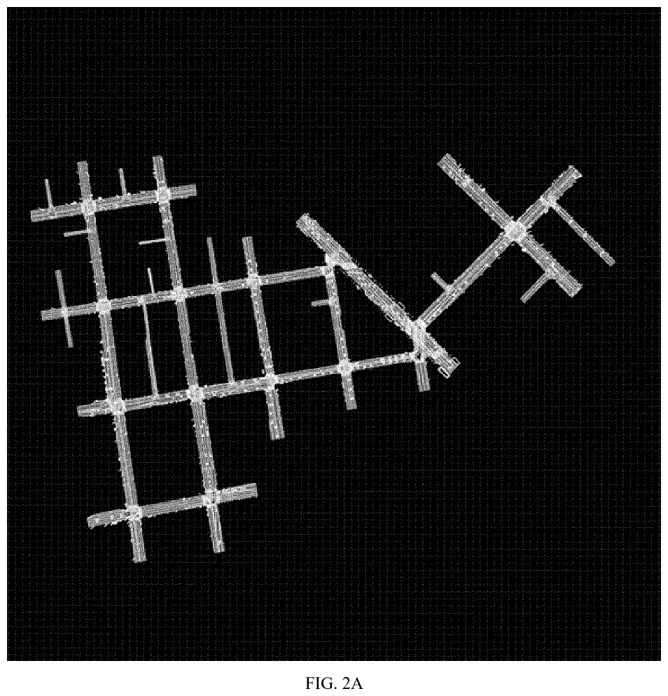

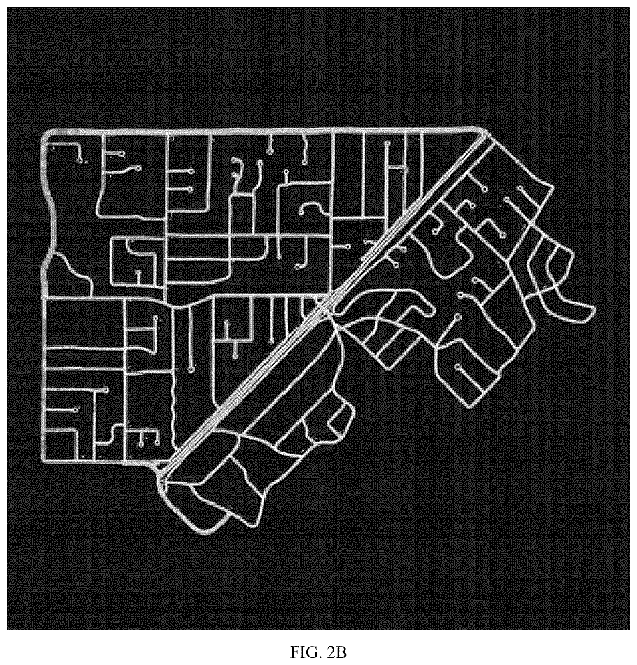

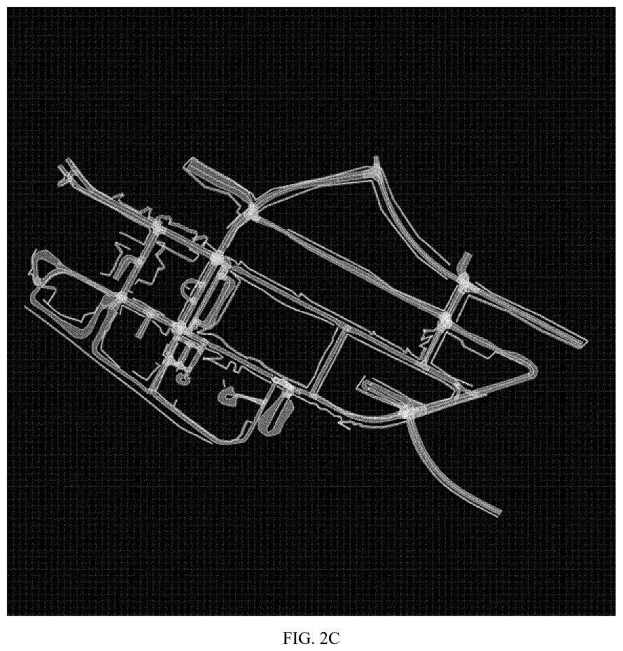

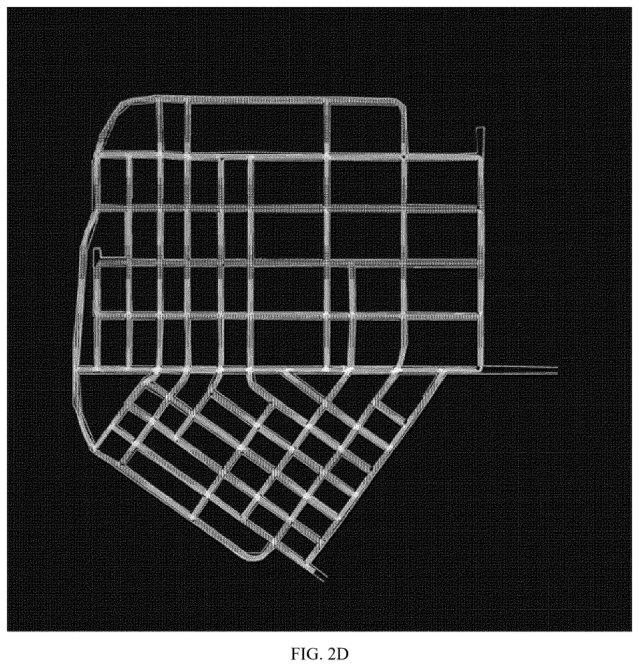

For example, a zero-watermark is generated as follows:
an original copyright image W is read, Logistic mapping is conducted to encrypt the copyright image, and an encrypted copyright image is obtained;
all elevations, superelevation and lane nodes in the high-definition map are used as elements, and numbers of parametric cubic curves in all the elements are computed separately, where FIGS. 2A-2D show illustrative data Data A, Data B, Data C and Data D of a high-definition map according to an embodiment of the present disclosure; and
any two elements are set as one group, and a stable index between watermark information and copyright information is established according to a formula (1), where index denotes an index value, Nᵢ and Nⱼ denote numbers of parametric cubic curves in different elements in one combination respectively, Nₘ denotes a one-dimensional length of the copyright image, and n denotes a total number of all the elevations, the superelevation and the lane nodes in the high-definition map.

$$index = mod ( ( {N}_{i} \times {N}_{j} ) , {N}_{m} ) , i , j ∈ \{ 1 , 2 , … , n \} and i \neq j \qquad ( 1 )$$

If a number of elevations, superelevation and lane nodes of a high-definition map is k, there are (k)! combinations in total. As enough combinations are provided, index values between different combinations may be consistent. Moreover, the watermark information is determined through a voting principle. A list having a consistent size with the copyright information is set for the voting principle, and the list is recorded as

$${M}^{′} = \{ {m}_{i}^{′} = 0 , i = 1 , 2 , … , {N}_{m} \} ,$$

where Nₘ denotes a size of the copyright information.

In response to determining that numbers of parametric cubic curves under two nodes in one combination have consistent parity, watermark information at a corresponding index of the combination is determined to be 1, in response to determining that numbers of parametric cubic curves under two nodes in one combination have no consistent parity, watermark information at a corresponding index of the combination is determined to be 0, and watermark information under a corresponding watermark index is computed according to a formula (2).

$${M}^{′} ( index ) = \{ \begin{matrix}{M}^{′} ( index ) + 1 , & if mod ( {N}_{i} , 2 ) = mod ( {N}_{j} , 2 ) \\ {M}^{′} ( index ) - 1 , & if mod ( {N}_{i} , 2 ) \neq mod ( {N}_{j} , 2 )\end{matrix} \qquad ( 2 )$$

After all nodes in the combination generate watermark information, binarization is conducted through a formula (3).

$${M}^{′} ( index ) = \{ \begin{matrix}1 , & if {M}^{′} ( index ) > 0 \\ 0 , & if {M}^{′} ( index ) \leq 0\end{matrix} , index ∈ ( 0 , {N}_{m} ) \qquad ( 3 )$$

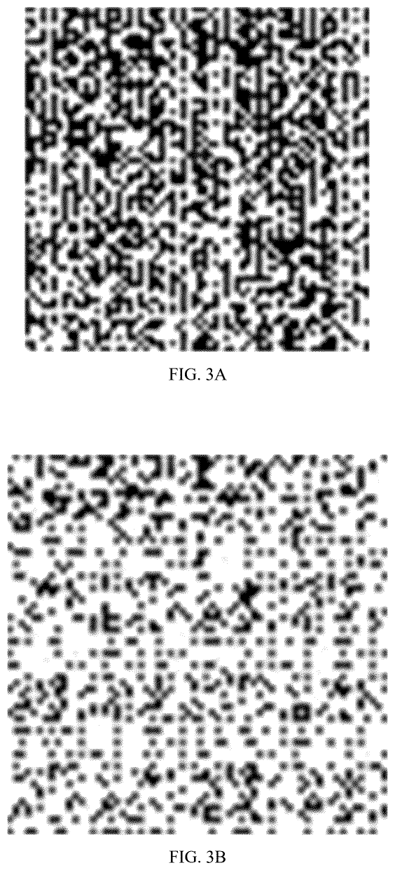

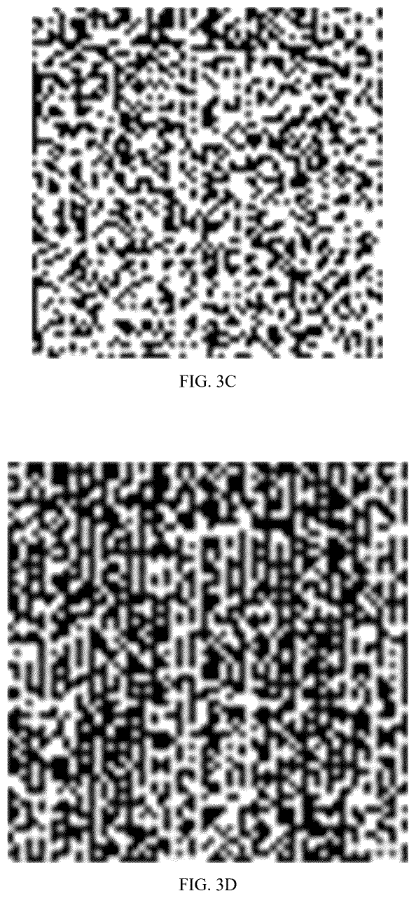

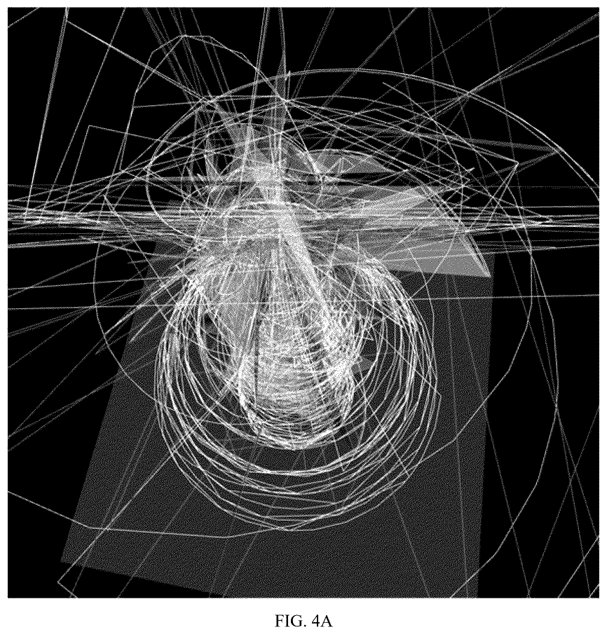

Exclusive OR (XOR) operation is conducted on the generated watermark information and the copyright information M according to a formula (4), and a zero-watermark M* is generated, where XNOR denotes an XOR operation symbol. FIGS. 3A-3D show zero-watermark images of Data A, Data B, Data C and Data D of a high-definition map according to an embodiment of the present disclosure.

$${M}^{*} = XNOR ( M , {M}^{′} ) \qquad ( 4 )$$

For example, a zero-watermark is extracted as follows:
data of the high-definition map of to-be-detected watermark information is read;
same watermark information is generated according to the zero watermarking method for data of a high-definition map, and binarization is conducted;
XOR operation is conducted on binarized watermark information and a zero-watermark of an original copyright image in an intellectual property management institution, and a to-be-detected copyright image encrypted is obtained; and

Logistic mapping decryption is conducted on the to-be-detected copyright image encrypted, and a detected copyright image is obtained.

For example, the data of the high-definition map is encrypted as follows:
permutation and combination are conducted on nucleotide bases, so as to obtain 24 combinations in total, which are marked as P={[ATGC], [ACTG], . . . , [TCGA]};
two random sequences L₁ and L₂ are generated through two-dimensional Henon-Sine mapping, where a definition of the Henon-Sine mapping is as shown in a formula (5), where μ and δ denote parameters, xᵢ and yᵢ denote iterative values, a range of both the iterative values is (−∞,+∞), and mod denotes a complementary function;

$$\{ \begin{matrix}{x}_{i + 1} = mod ( ( 1 - {μsin}^{2} ( {x}_{i} ) + {y}_{i} ) , 1 ) \\ {y}_{i + 1} = mod ( δ {x}_{i} , 1 )\end{matrix} \qquad ( 5 )$$

permutation and encryption are conducted on a combination of nucleotide bases through the random sequence L₁, so as to improve security;
the random sequence L₂ is used as a control parameter, and a base combination corresponding to each parametric cubic curve in elevations, superelevation and lanes is determined according to a formula (6), where index denotes an index between the parametric cubic curve and the base combination, int denotes a least integer function, lᵢ denotes a random number in the random sequence L₂, k denotes an amplification parameter, and s denotes an S coordinate of the elevations, the superelevation and a starting position of the lanes;

$$index = mod ( int ( s \times {l}_{i} \times {10}^{k} ) , 24 ) , {l}_{i} ∈ {L}_{2} \qquad ( 6 )$$

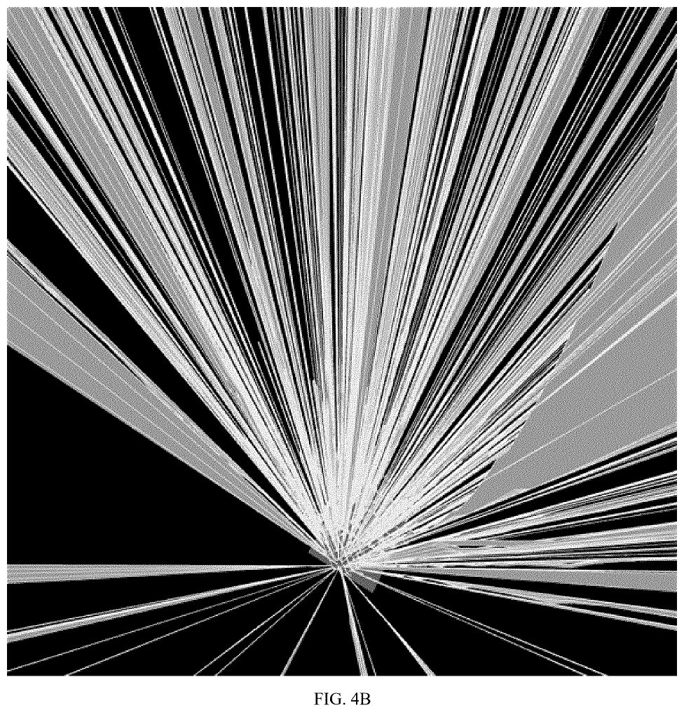

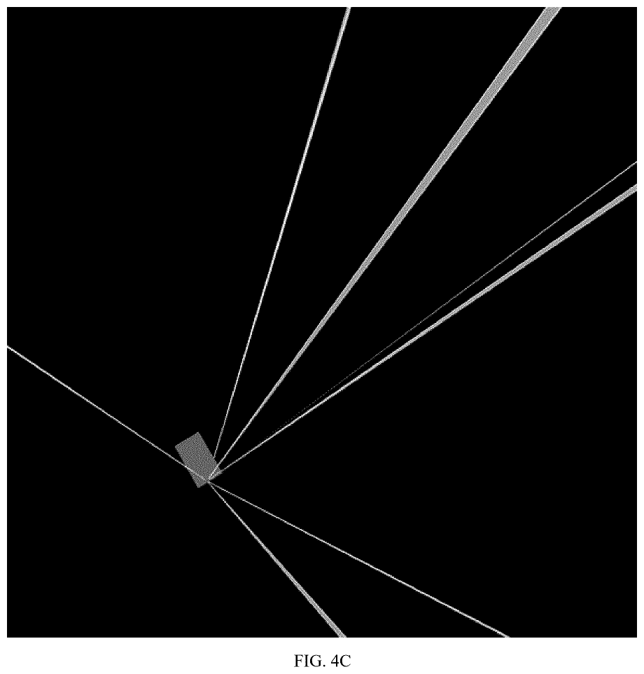

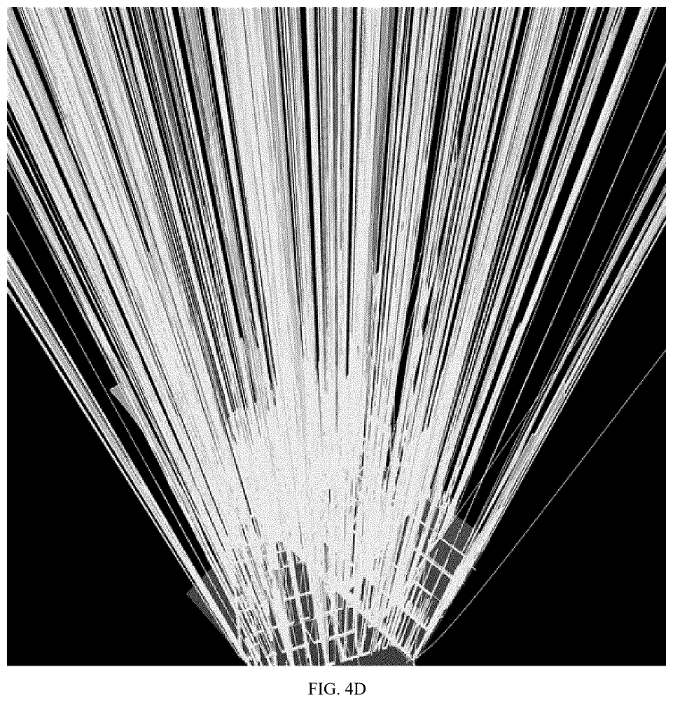

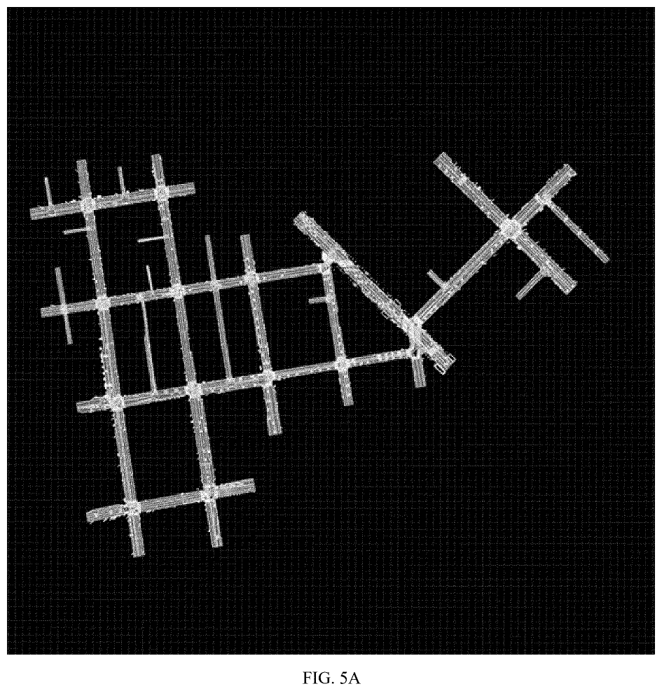

after a correspondence between each parametric cubic curve and a nucleotide base combination is determined, a complementary chain is determined according to a DNA base complementary pairing principle, and in response to determining that a base combination corresponding to four parameters (a,b,c,d) in one parametric cubic curve is (A,G,C,T), a complementary chain of the base combination is determined as (T,C,G,A); and
(a,b,c,d) is encrypted according to a permutation mode of the complementary chain, and four parameters in an original parametric cubic curve are replaced with four encrypted parameters, so as to complete encryption. FIGS. 4A-4D show encryption effects of Data A, Data B, Data C and Data D of a high-definition map according to an embodiment of the present disclosure.

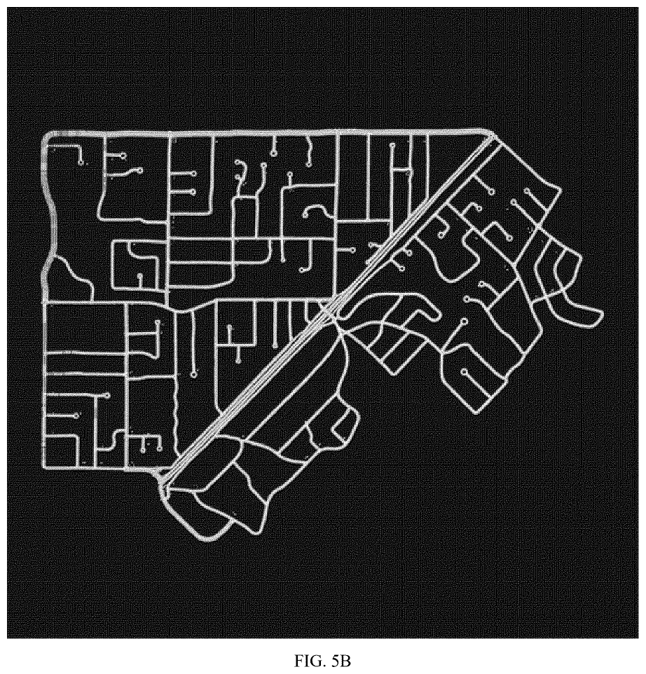

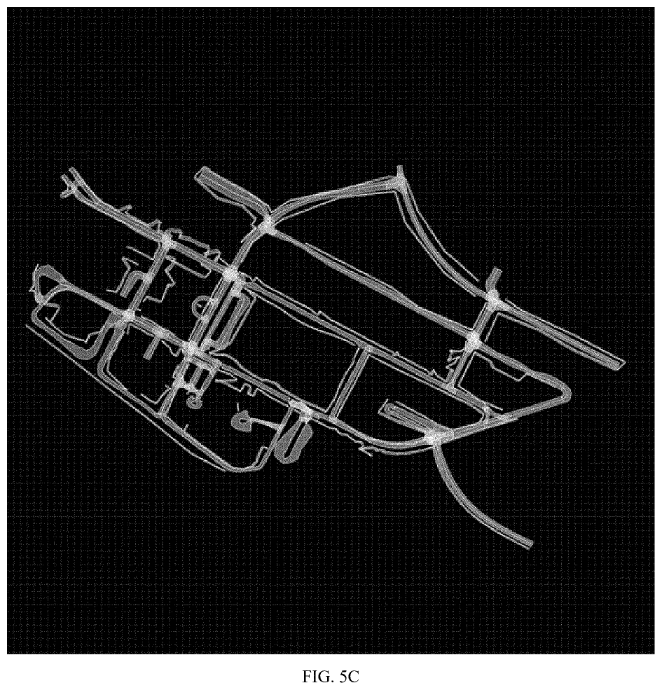

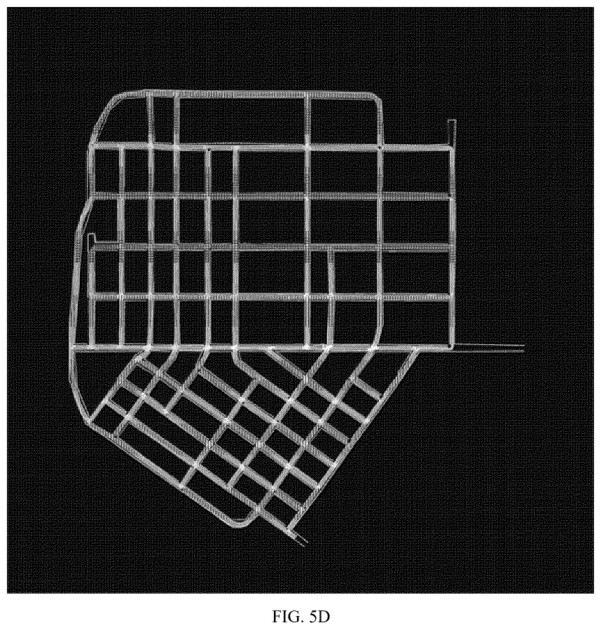

For example, the data of the high-definition map is decrypted as follows:
data of a to-be-decrypted high-definition map is read;
same permutation and combination are conducted on nucleotide bases;
two same random sequences L₁ and L₂ are generated through two-dimensional Henon-Sine mapping according to the encryption method for data of a high-definition map;
a base combination corresponding to each parametric cubic curve in elevations, superelevation and lanes is determined through the encryption method for data of a high-definition map; and
a corresponding complementary base is derived according to a base; and finally, four parameters (a,b,c,d) in the parametric cubic curve are decrypted and replaced according to a permutation mode of the complementary base, so as to complete decryption. FIG. 5A shows a visualization effect of encrypted data of Data A encrypted in FIG. 4A after decryption according to an embodiment of the present disclosure. FIG. 5B shows a visualization effect of encrypted data of Data B encrypted in FIG. 4B after decryption according to an embodiment of the present disclosure. FIG. 5C shows a visualization effect of encrypted data of Data C encrypted in FIG. 4C after decryption according to an embodiment of the present disclosure. FIG. 5D shows a visualization effect of encrypted data of Data D encrypted in FIG. 4D after decryption according to an embodiment of the present disclosure.

The above description of the disclosed examples enables those skilled in the art to implement or use the present disclosure. Various modifications to the embodiments are readily apparent to professionals skilled in the art, and the general principles defined herein can be implemented in other embodiments without departing from the spirit or scope of the present disclosure. Thus, the present disclosure is not limited to the embodiments shown herein but falls within the widest scope consistent with the principles and novel features disclosed herein.

What is claimed is:

1. A zero watermarking method for data of a high-definition map in an OpenDrive format, comprising:
conducting Logistic encryption on a copyright image, obtaining an encrypted copyright matrix M, and conducting binarization on the copyright matrix;
using all elevations, superelevation and lane nodes in the high-definition map as elements, and computing numbers of parametric cubic curves in all the elements separately;
setting any two elements as one group, and establishing a stable index between watermark information and copyright information according to a formula (1), wherein index denotes an index value, Nᵢ and Nⱼ denote numbers of parametric cubic curves in different elements in one combination respectively, Nₘ denotes a one-dimensional length of the copyright image, and n denotes a total number of all the elevations, the superelevation and the lane nodes in the high-definition map;
$$index = mod ( ( {N}_{i} \times {N}_{j} ) , {N}_{m} ) , i , j ∈ \{ 1 , 2 , … , n \} and i \neq j$$
setting a list having a consistent size with the copyright information, and recording the list as
$${M}^{′} = \{ {m}_{i}^{′} = 0 , i = 1 , 2 , … , {N}_{m} \} ,$$
wherein
$${m}_{i}^{′}$$
denotes an element in the list;
determining, in response to determining that numbers of parametric cubic curves under two nodes in one combination have consistent parity, watermark information at a corresponding index of the combination to be 1, determining, in response to determining that numbers of parametric cubic curves under two nodes in one combination have no consistent parity, watermark information at a corresponding index of the combination to be 0, and computing watermark information under a corresponding watermark index according to the following formula;
$${M}^{′} ( index ) = \{ \begin{matrix}{M}^{′} ( index ) + 1 , & if mod ( {N}_{i} , 2 ) = mod ( {N}_{j} , 2 ) \\ {M}^{′} ( index ) - 1 , & if mod ( {N}_{i} , 2 ) \neq mod ( {N}_{j} , 2 )\end{matrix}$$
conducting, after all nodes in the combination generate watermark information, binarization through the following formula; and
$${M}^{′} ( index ) = \{ \begin{matrix}1 , & if {M}^{′} ( index ) > 0 \\ 0 , & if {M}^{′} ( index ) \leq 0\end{matrix} , index ∈ ( 0 , {N}_{m} )$$
conducting exclusive OR (XOR) operation on the generated watermark information M′ and the encrypted copyright image M according to the following formula, and generating a zero-watermark M*, wherein XNOR denotes an XOR operation symbol:
$${M}^{*} = XNOR ( M , {M}^{′} ) .$$

2. A method for detecting zero-watermark information, comprising:
generating watermark information according to the zero watermarking method for data of a high-definition map in an OpenDrive format according to claim 1;
conducting XOR operation on the generated watermark information and a zero-watermark M*;
conducting Logistic mapping decryption on a result of the XOR operation, and obtaining a to-be-detected copyright image; and
computing similarity between the to-be-detected copyright image and an original copyright image.

3. An encryption method for data of a high-definition map in an OpenDrive format, comprising:
conducting permutation and combination on nucleotide bases, so as to obtain 24 combinations in total, which are marked as P={[ATGC], [ACTG], . . . , [TCGA]};
generating two random sequences L₁ and L₂ through two-dimensional Henon-Sine mapping, wherein a definition of the Henon-Sine mapping is as shown in the following formula, wherein μ and δ denote parameters, xᵢ and yᵢ denote iterative values, a range of both the iterative values is (−∞,+∞), and mod denotes a complementary function;
$$\{ \begin{matrix}{x}_{i + 1} = mod ( ( 1 - {μsin}^{2} ( {x}_{i} ) + {y}_{i} ) , 1 ) \\ {y}_{i + 1} = mod ( δ {x}_{i} , 1 )\end{matrix}$$
conducting permutation and encryption on a combination of nucleotide bases through the random sequence L₁, so as to improve security;
using the random sequence L₂ as a control parameter, and determining a base combination corresponding to each parametric cubic curve in elevations, superelevation and lanes according to the following formula, wherein index denotes an index between the parametric cubic curve and the base combination, int denotes a least integer function, lᵢ denotes a random number in the random sequence L₂, k denotes an amplification parameter, and s denotes an S coordinate of the elevations, the superelevation and a starting position of the lanes;
$$index = mod ( int ( s \times {l}_{i} \times {10}^{k} ) , 24 ) , {l}_{i} ∈ {L}_{2}$$
determining, after a correspondence between each parametric cubic curve and a nucleotide base combination is determined, a complementary chain according to a DNA base complementary pairing principle, and determining, in response to determining that a base combination corresponding to four parameters (a,b,c,d) in one parametric cubic curve is (A,G,C,T), a complementary chain of the base combination as (T,C,G,A); and
encrypting (a,b,c,d) according to a permutation mode of the complementary chain, and replacing four parameters in an original parametric cubic curve with four encrypted parameters, so as to complete encryption.

4. A decryption method for data of a high-definition map in an OpenDrive format, comprising:
reading a to-be-decrypted high-definition map in an OpenDrive format;
conducting same permutation and combination on nucleotide bases according to the encryption method for data of a high-definition map in an OpenDrive format according to claim 3, and generating two same random sequences L₁ and L₁ through Henon-Sine mapping;
conducting permutation and encryption on a nucleotide base combination through L₁, and determining a base combination corresponding to each parametric cubic curve in elevations, superelevation and lanes through L₂; and
deriving a corresponding complementary base according to a base; and finally, decrypting and replacing four parameters (a,b,c,d) in the parametric cubic curve according to a permutation mode of the complementary base, so as to complete decryption.

5. A commutative encryption and watermarking method utilizing DNA base complementary dynamic encryption for a high-definition map, comprising:
reading data of the high-definition map in an OpenDrive format;
constructing a zero-watermark image according to the zero watermarking method for data of a high-definition map in an OpenDrive format;
encrypting the data of the high-definition map according to the encryption method for data of a high-definition map in an OpenDrive format; and
commutative sequences of zero-watermark construction and high-definition map data encryption.
